(19) United States
(12) Patent Application Publication
(10) Pub. No.: US 2015/0239444 A1
(43) Pub. Date: Aug. 27, 2015

(54) BRAKE FLUID PRESSURE CONTROL ACTUATOR

(71) Applicants: DENSO CORPORATION, Kariya-city (JP); Advics Co., Ltd., Kariya-city (JP)

(72) Inventors: FUMITOSHI KOYAMA, Kariya-shi (JP); KIMIYOSHI ISOGAI, Anjo-shi (JP); KENJI MURAKAMI, Chiryu-shi (JP)

(21) Appl. No.: 14/631,086

(22) Filed: Feb. 25, 2015

(30) Foreign Application Priority Data
Feb. 26, 2014 (JP) 2014-035528

(51) Int. Cl. B60T 8/34; B60T 8/171

(52) U.S. Cl. CPC B60T 8/34; B60T 8/171

(57) ABSTRACT

When a first and a second reservoirs are disposed at positions below a central axis of pumps and are offset from a center portion in a lateral direction of a housing when viewed from a front surface side, outer peripheral sides of a first and a second reservoir usually become dead spaces. Therefore, first and second wheel pressure sensors are disposed in the dead spaces.

### CROSS-REFERENCE TO RELATED APPLICATION

This application is based on and claims the benefit of priority from earlier Japanese Patent Application No. 2014-35528 filed Feb. 26, 2014, the description of which is incorporated herein by reference.

### TECHNICAL FIELD

The present disclosure relates to a brake fluid pressure control actuator used to control brake fluid pressure of a vehicle, such as for ABS control and traction control, for example.

### BACKGROUND

A conventional brake fluid pressure control actuator is disclosed in Japanese Patent Publication No. 5279832, for example.

The brake fluid pressure control actuator disclosed in the Publication '832 is for adjusting pressure of wheel cylinders (hereinafter referred to as W/C), and performs an ABS control that avoids a tendency to produce a wheel lock by increasing or decreasing the pressure of the W/C, for example.

Further, upon newly adopting a wheel pressure sensor for detecting the brake fluid pressure of the W/C, the brake fluid pressure control actuator employs a new configuration of a housing where a plurality of electromagnetic valves, pumps, reservoirs, and wheel pressure sensors, etc. are attached.

Specifically, the housing is a rectangular parallelepiped, and the pump and reservoirs are accommodated within the housing, while the solenoid valves and the wheel pressure sensors are disposed on a front surface of the housing.

Further, the pumps are disposed in a substantially central portion in the vertical direction of the housing, the reservoirs are disposed below the pumps, and the wheel pressure sensors are disposed below the pumps and above the reservoirs.

However, since the pumps, the reservoirs, and the wheel pressure sensors are arranged serially in a vertical direction in the brake fluid pressure control actuator disposed in the Publication '832, there is a problem that a vertical dimension of the housing increases.

### SUMMARY

An embodiment provides a brake fluid pressure control actuator having a wheel pressure sensor that can reduce the size of its housing

In a brake fluid pressure control actuator according to a first aspect, the brake fluid pressure control actuator includes a housing having a front surface, a back surface, and a plurality of side surfaces, and to which piping that connects a master cylinder and wheel cylinders is formed.

The brake fluid pressure control actuator further includes a plurality of control valves for controlling a brake fluid pressure applied to the wheel cylinders, and the control valves are disposed in the front surface.

The brake fluid pressure control actuator further includes a reservoir for temporarily storing a brake fluid discharged from the wheel cylinders, and the reservoir being accommodated in a reservoir accommodating hole opened in the first side surface among the plurality of side surfaces.

The brake fluid pressure control actuator further includes a pump for sucking the brake fluid from the reservoir and discharging it towards the piping, and the pump is accommodated in the housing.

The brake fluid pressure control actuator further includes a wheel pressure sensor for detecting the brake fluid pressure of the wheel cylinders, and the wheel pressure sensor being disposed on an outer peripheral side of the reservoir in the housing.

Accordingly, it is possible to reduce the size of the housing by disposing the wheel pressure sensor on the outer peripheral side of the reservoir in order to avoid the pump, the reservoir, and the wheel pressure sensor being arranged in series.

### BRIEF DESCRIPTION OF THE DRAWINGS

In the accompanying drawings:

FIG. 1 shows a schematic diagram of a brake fluid pressure control system that a brake fluid pressure control actuator according to an embodiment of the present disclosure has;

FIG. 2 shows a front layout view when a casing and a circuit board are removed from the brake fluid pressure control actuator shown in FIG. 1; and

FIG. 3 shows a layout view of the brake fluid pressure control actuator viewed from the left side of FIG. 2

### DETAILED DESCRIPTION OF THE PREFERABLE EMBODIMENT

An embodiment of the present disclosure is described.

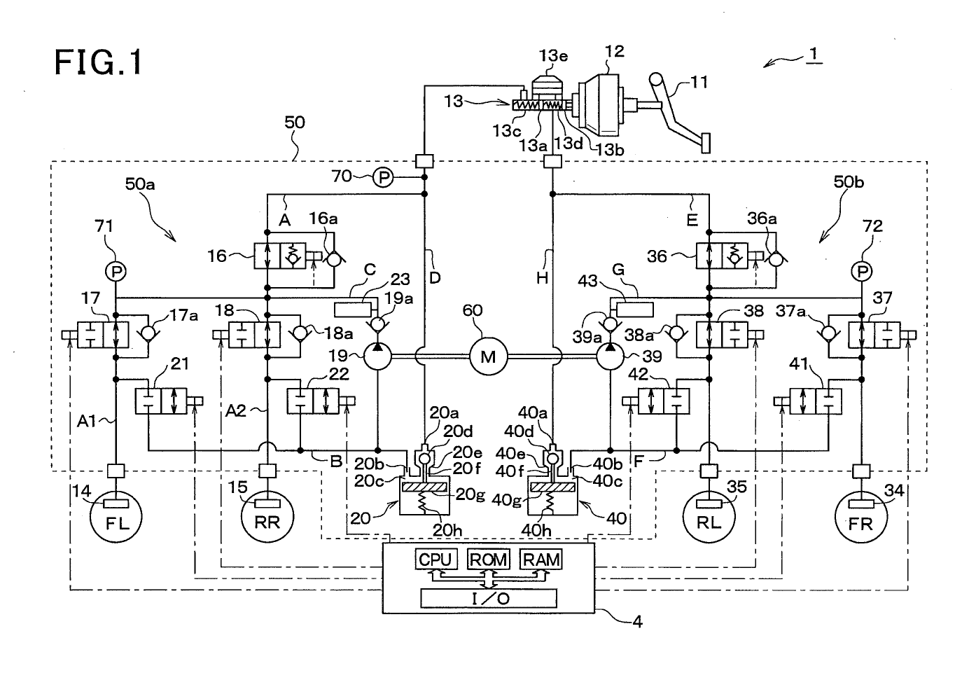

With reference to FIG. 1, hereinafter will be described a configuration of the brake fluid pressure control system 1 of the embodiment.

A brake pedal 11, as a brake operating member that is depressed by a driver when applying a braking force to a vehicle, is connected to a booster 12, which is a brake fluid pressure generating source, and a master cylinder (hereinafter referred to as M/C) 13.

When the driver depresses the brake pedal 11, the pedal force is boosted at the booster 12, and presses master pistons 13a, 13b disposed in the M/C 13.

Thus, the same M/C pressure is generated in a primary chamber 13c and a secondary chamber 13d which is defined by the master piston 13a, 13b.

The M/C 13 is provided with a master reservoir 13e that has passages respectively communicating with the primary chamber 13c and the secondary chamber 13d.

The master reservoir 13e supplies the brake fluid in the M/C 13, or stores an excess brake fluid in the M/C 13 through the passages.

Since each of the passage are formed with a much smaller diameter than diameters of main conduits extending from the primary chamber 13c and the secondary chamber 13d, an orifice effect is exerted when the brake fluid flows into the master reservoir 13e from the primary chamber 13c and the secondary chamber 13d.

The M/C pressure generated in the M/C 13 is transmitted to each wheel cylinder (hereinafter referred to as W/C) 14, 15, 34, 35 through a brake fluid pressure control actuator 50.

The brake fluid pressure control actuator 50 is formed of a first piping system 50a and a second piping system 50b.

The first piping system 50a is used for controlling the brake fluid pressure applied to a left front wheel FL and a right rear wheel RR.

The second piping system 50b is used for controlling the brake fluid pressure applied to a right front wheel FR and a left rear wheel RL.

An X-piping is composed of two piping systems, namely the first and second piping systems 50a, 50b.

Hereinafter, although the first and second piping systems 50a, 50b are described, the first piping system 50a and the second piping system 50b have substantially the same configuration.

Therefore, only the first piping system 50a is described here, and a description of the second piping system 50b will be omitted by referring to the first piping system 50a.

A conduit A as a main conduit for transmitting the above-mentioned M/C pressure to the W/C 14 provided in the left front wheel FL and the W/C 15 provided in the right rear wheel RR in the first piping system 50a.

The W/C pressure in each of the W/C 14, 15 is generated through the conduit A.

In addition, a first differential pressure control valve 16 is provided to the conduit A. The first differential pressure control valve is formed of an electromagnetic valve capable of controlling two positions of a communicating state and a differential pressure state.

A valve position of the first differential pressure control valve 16 is in the communicating state during a normal braking state, and the valve position becomes in the differential pressure state when a power is supplied to a solenoid coil.

In the valve position of the differential pressure state in the first differential pressure control valve 16, a flow of brake fluid only to the M/C 13 from the W/C 14,15 is permitted only when the brake fluid pressure in the W/C 14, 15 becomes higher than a predetermined M/C pressure.

Therefore, the brake fluid pressure is maintained so that the pressure in the W/C 14, 15 does not become higher than the pressure in the M/C 13 side in predetermined pressure continuously, thus each conduit is protected.

The conduit A branches into two conduits A1, A2 at a downstream side of the first differential pressure control valve 16 in the W/C 14, 15. A first boost control valve 17 for controlling a pressure increase of the brake fluid pressure to the W/C 14 is provided to one of the two conduits A1, A2, and a second boost control valve 18 for controlling a pressure increase of the brake fluid pressure to the W/C 15 is provided to another one of the two conduits A1, A2.

Each of the first and second boost control valves 17, 18 is composed of an electromagnetic valve as a two-position valve capable of producing a communicating state and a cut off state.

Then, when the first and second boost control valves 17, 18 are controlled in the communicating state, the M/C pressure or the brake fluid pressure by a discharging of the brake fluid from a pump 19 described later can be applied to the W/C 14, 15.

In the normal braking state performed by an operation of the brake pedal 11 by the driver, the first differential pressure control valve 16 and the first and second boost control valves 17, 18 are constantly controlled to be in the communicating state.

Further, safety valves 16a, 17a, 18a are provided in parallel to the first differential pressure control valve 16 and the first and the second boost control valves 17, 18, respectively.

The safety valve 16a of the first differential pressure control valve 16 is disposed in order to transmit the M/C pressure to the W/C 14, 15 when the brake pedal 11 is depressed by the driver during the valve position of the first differential pressure control valve 16 is in the differential pressure state.

Moreover, when the brake pedal 11 is returned by the driver during the boost control valves 17, 18 is controlled to the cut off state, especially during an ABS (Anti-lock Braking System) control, the safety valves 17a, 18a of the boost control valves 17, 18 are disposed in order to decompress the W/C pressure of the left front wheel FL and the rear right wheel RR in response to a return operation of the brake pedal 11.

A conduit B is a decompression conduit connecting between the first and second boost control valves 17, 18, and each W/C 14, 15 in the conduit A with a first reservoir 20. The conduit B is provided with a first pressure reduction control valve 21 and a second pressure reduction control valve 22, each of which is composed of an electromagnetic valve as a two-position valve capable of controlling a communicating state and a cut off state.

The first and second pressure reduction control valves 21, 22 are constantly in the cut off state during normal braking.

A conduit C is disposed as a return conduit so as to connect between the conduit A that is the main conduit and the first reservoir 20. The pump 19 driven by a motor 60 is provided in the conduit C so as to suck/discharge the brake fluid toward the M/C 13 side or the W/C 14, 15 from the first reservoir 20. It should be noted that the pump 19 is a gear pump.

A safety valve 19a is provided at a discharge port side of the pump 19 so that a high-pressure brake fluid is not applied to the pump 19. In addition, a fixed volume damper 23 is provided on a discharge side of the pump 19 in the conduit C for relieving a pulsation of the brake fluid discharged from the pump 19.

Then, a conduit D that becomes an auxiliary conduit so as to connect the first reservoir 20 and the M/C 13 is provided.

The brake fluid is supplied to the W/C 14, 15 through the conduit D in order to increase the W/C pressure of the objected wheel by sucking the brake fluid from the M/C 13 by the pump 19 and discharging it into the conduit A during a TCS (Traction Control System) control or the ABS control.

The first reservoir 20 has a reservoir hole 20a connected to the conduit D that accepts the brake fluid from the M/C 13, and another reservoir hole 20b connected to the conduit B and the conduit C that accepts the brake fluid released from the W/C 14, 15 while supplies the brake fluid to the suction side of the pump 19, and the reservoir holes 20a, 20b are communicated with the reservoir chamber 20c.

A ball valve 20d is disposed in inner side of the reservoir hole 20a. A rod 20f having a predetermined stroke for moving the ball valve 20d up and down is provided separately to the ball valve 20d.

Further, a piston 20g interlocking with the rod 20f, and a spring 20h that generates a force to push out the brake fluid in the reservoir chamber 20c by pressing the piston 20g towards the ball valve 20d are provided in the reservoir chamber 20c.

In the first reservoir 20 having such a configuration, the ball valve 20d is seated on the valve seat 20e so that the brake fluid does not flow into the first reservoir 20 when a predetermined amount of brake fluid is stored therein.

Therefore, the brake fluid exceeding the suction capability of the pump 19 will not flow into the reservoir chamber 20c, and a high pressure is not applied to the suction side of the pump 19.

A master pressure sensor 70 is disposed between the M/C 13 and the first differential pressure control valve 16 in the conduit A. The master pressure sensor 70 detects the M/C pressure generated in the M/C 13.

Further, a first wheel pressure sensor 71 is disposed between the first differential pressure control valve 16 and the first boost control valve 17 in the conduit A, or between the first differential pressure control valve 16 and the second boost control valve 18 in the conduit A.

The first wheel pressure sensor 71 detects the brake fluid pressure of the W/C 14, 15 in the first piping system 50a

On the other hand, as described above, the second piping system 50b has a structure substantially similar to that of the first piping system 50a. That is, the first differential pressure control valve 16 corresponds to a second differential pressure control valve 36.

The first and the second boost control valves 17, 18, respectively correspond to third and fourth boost control valves 37 and 38, the first and the second pressure reducing valves 21, 22 respectively correspond to third and fourth vacuum control valves 41, 42.

The first reservoir 20 corresponds to a second reservoir 40. The pump 19 corresponds to a pump 39. The damper 23 corresponds to a damper 43. The first wheel pressure sensor 71 corresponds to a second wheel pressure sensor 72. In addition, the conduit A, the conduit B, the conduit C, and the conduit D respectively corresponds to a conduit E, a conduit F, a conduit G, and a conduit H.

As described above, a hydraulic piping structure is constructed in the brake fluid pressure control system 1.

In addition, a brake control ECU 4 as a control unit is provided in the brake fluid pressure control system 1.

The brake control ECU 4, is constituted by a well-known microcomputer including a CPU, a ROM, a RAM, a I/O, and the like, and executes a processing of various operations according to a program stored in the ROM.

A voltage applying control to the motor 60 for driving the control valves 16-18, 21, 22, 36-38, 41, 42 and the pump 19, 39 in the brake fluid pressure control actuator 50 configured as described above is executed based on electrical signals from the brake control ECU 4.

Thereby, the control of the W/C pressure generated in each W/C 14, 15, 34, 35 is carried out.

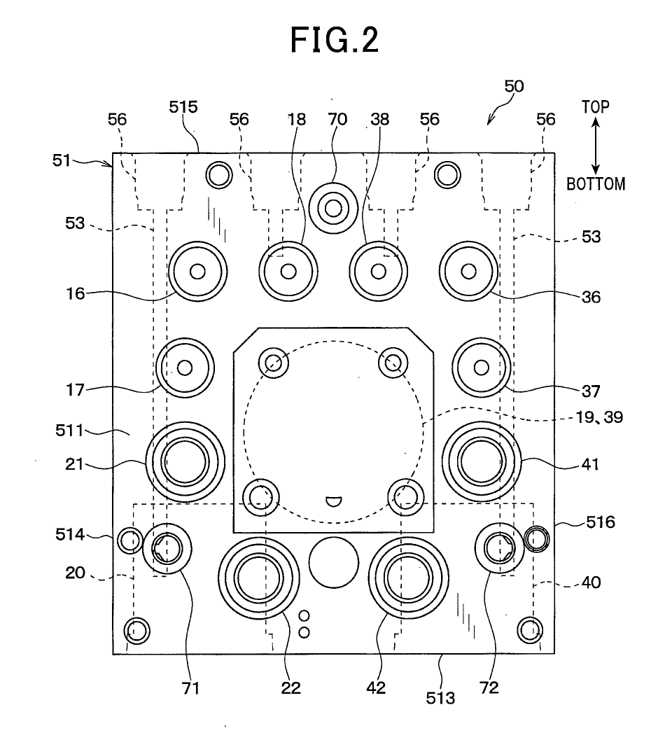

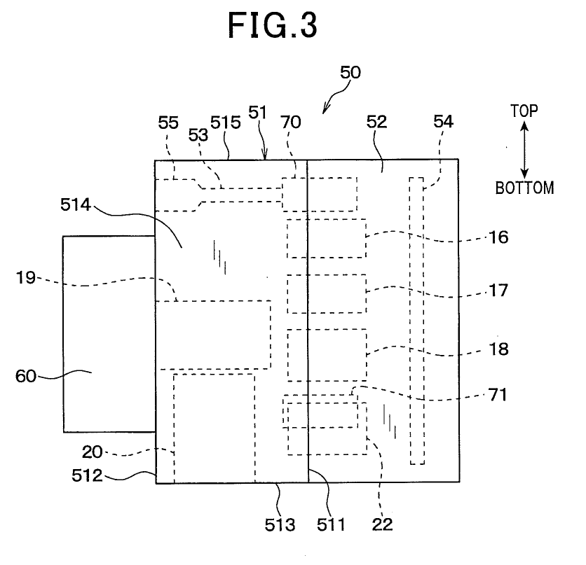

Next, an arrangement of each component in the brake fluid pressure control actuator 50 having a piping structure as described above will be described with reference to FIGS. 2 and 3.

The brake fluid pressure control actuator 50 is mounted onto a vehicle so as a top-bottom direction in FIGS. 2 and 3 is directed to a vertical direction.

As shown in FIGS. 2 and 3, the brake fluid pressure control actuator 50 has a housing 51 made of aluminum. The housing 51 is a substantially rectangular parallelepiped shape, and includes a front surface 511, a back surface 512, and first-fourth side surfaces 513-516.

It should be noted that in the first-fourth side surfaces 513-516, a side surface positioned at the bottom is the first side surface 513, and a side surface positioned at the top is the third side surface 515.

In addition, a side surface positioned on the left when viewed from the front surface side surface 511 is the second side surface 514, and a side surface positioned on the right when viewed from the front surface side surface 511 is the fourth side surface 516.

Valve insertion holes (not shown) where the first and the second differential pressure control valves 16, 36, the first-fourth boost control valves 17, 18, 37, 38, and the first-fourth vacuum control valves 21, 22, 41, 42 are inserted, pump accommodating holes (not shown) where the pumps 19, 39 are accommodated, reservoir accommodating holes (not shown) where the first and the second the reservoir 20, 40 are accommodated, and sensor insertion holes (not shown) where the master pressure sensor 70, the first and second the wheel pressure sensors 71, 72 are inserted, are formed in the housing 51.

In addition, the valve insertion holes and the sensor insertion holes are opened to the front surface 511, and the pump accommodating holes are opened to the back surface 512.

Further, the reservoir accommodating holes are opened to the first side surface 513, and are substantially cylindrical spaces extending in a direction perpendicular to the first side surface 513.

Piping 53 for performing the brake fluid pressure control is bored in the housing 51. The conduits A-H are constituted by the piping 53.

The first and the second differential pressure control valves 16, 36, the first-fourth boost control valves 17, 18, 37, 38, the first-the fourth pressure reduction control valves 21, 22, 41, 42, the pumps 19, 39, the first and the second reservoirs 20, 40, the master pressure sensor 70, and the first and the second wheel pressure sensors 71, 72, etc. are disposed in the housing 51 so as to be connected to the piping 53.

The pumps 19, 39 and the motor 60, as viewed from the front surface 511 side, are disposed in a position at a center portion in a lateral direction of the housing 51, and are disposed in a position slightly below the center portion in the vertical direction of the housing 51.

The motor 60 is fixed to the back surface 512, and the pumps 19, 39 are driven through a motor drive shaft (not shown).

It should be noted that center axes of the pumps 19, 39 and the motor 60 (hereinafter referred to as a pump center axis) is perpendicular to the front surface 511 and the back surface 512 (i.e., a direction perpendicular to a plane of FIG. 2, a left-right direction in FIG. 3).

The first and the second differential pressure control valves 16, 36, the first-fourth boost control valves 17, 18, 37, 38, the first-fourth vacuum control valves 21, 22, 41, 42 are disposed on the front surface 511, and are disposed so as to surround the pumps 19, 39 when viewed from the front surface 511 side.

Specifically, the four valves are disposed in a row on an upper side of the pumps 19, 39, and the first differential pressure control valve 16, the second pressure control the valve 18, the fourth boost control valves 38, and the second differential pressure control valve 36 are disposed in this order from the left toward the right when viewed from the front surface 511 side.

Further, the first differential pressure control valve 16 is positioned on the left side of the pumps 19, 39, and the second differential pressure control valve 36 is positioned on the right side of the pumps 19, 39 when viewed from the front surface 511 side.

The first boost control valve 17 is disposed substantially beneath the first differential pressure control valve 16 and on the left side of the pumps 19, 39 when viewed from the front surface 511 side.

The first pressure reduction control valve 21 is disposed substantially beneath the first boost control valve 17 and on the right side of the pumps 19, 39 when viewed from the front surface 511 side.

The third boost control valve 37 is disposed substantially beneath the second differential pressure control valve 36 and on the right side of the pumps 19, 39 when viewed from the front surface 511 side.

The third pressure reducing valve 41 is disposed substantially beneath the third boost control valve 37 and on the right side of the pumps 19, 39 when viewed from the front surface 511 side.

The second pressure reducing valve 22 and the fourth pressure reducing valve 42 are disposed below the pumps 19, 39, the first pressure reduction control valve 21, and the third pressure reduction control valve 41 when viewed from the front surface 511 side.

Further, the second pressure reducing valve 22 is positioned closer to the pump center axis than the first pressure reduction control valve 21, and the fourth pressure reducing valve 42 is positioned closer to the pump center axis than the third pressure reduction control valve 41 is when viewed from the front surface 511 side.

The first and the second reservoirs 20, 40 are disposed at positions below the pump center axis and are offset from the center portion in the lateral direction of the housing 51 when viewed from the front surface 511 side.

More specifically, the first reservoir 20 is positioned near a corner defined by the first side surface 513 and the second side surface 514, and is positioned so that a central axis of the first reservoir 20 extends in a direction perpendicular to the of the first side surface 513 (i.e., the top-bottom direction in FIG. 2).

Further, the second reservoir 40 is positioned near a corner defined by the first side surface 513 and the fourth side surface 516, and is positioned so that a central axis of the second reservoir 40 extends in a direction perpendicular to the first side surface 513.

The master pressure sensor 70 is disposed on the front surface 511. The master pressure sensor 70 is positioned above the first differential pressure control valve 16, the second boost control valves 18, the fourth boost control valves 38, and the second differential pressure control valve 36 , and is positioned in the center in the lateral direction of the housing 51 when viewed from the front surface 511 side.

The first wheel pressure sensor 71 is disposed in the front surface 511, and is positioned substantially below the first pressure reducing valve 21 and on an upper left side of the second pressure reducing valve 22 when viewed from the front surface 511 side.

Further, the first wheel pressure sensor 71 is disposed at a position below the pump center axis and is offset from the center portion in the lateral direction of the housing 51 when viewed from the front surface 511 side.

Moreover, the first wheel pressure sensor 71 is positioned on an outer peripheral side of the first reservoir 20, and is positioned within a projecting plane of the first reservoir 20 when viewed from the front surface 511 side.

Further, a central axis of the first wheel pressure sensor 71 is perpendicular to a central axis of the first reservoir 20, and is shifted to the left of the center axis of the first reservoir 20 when viewed from the front surface 511 side.

The second wheel pressure sensor 72 is disposed in the front surface 511, and is positioned substantially below the third pressure reducing valve 41 and on an upper right side of the fourth pressure reducing valve 42 when viewed from the front surface 511 side.

Further, the second wheel pressure sensor 72 is disposed at a position below the pump center axis and is offset from the center portion in the lateral direction of the housing 51 when viewed from the front surface 511 side.

Moreover, the second wheel pressure sensor 72 is positioned on an outer peripheral side of the second reservoir 40, and is positioned within a projecting plane of the second reservoir 40 when viewed from the front surface 511 side.

Further, a central axis of the second wheel pressure sensor 72 is perpendicular to a central axis of the second reservoir 40, and is shifted to the left of the center axis of the second reservoir 40 when viewed from the front surface 511 side.

A casing 52 accommodates a circuit board 54 to which the brake control ECU 4 is provided, and is for preventing various control valves from touching water or the like.

The casing 52 is fixed to the front surface 511 of the housing 51, and various control valves and sensors are covered by the casing 52.

Further, the housing 51 is provided with a port 55 for connection to the M/C 13, has four ports 56 for connecting the piping 53 to the W/C 14, 15, 34, 35.

The port 55 is connected to the M/C 13 is formed in an upper position of the back surface 512 of the housing 51, and the four ports 56 connected to the W/C 14, 15, 34 ,35 are disposed in a row on an upper surface of the housing 51.

The brake fluid pressure control actuator 50 of the above structure avoids the pumps 19, 39, the first reservoir 20, and the first wheel pressure sensor 71 being arranged in series by disposing the first wheel pressure sensor 71 on the outer peripheral side of the first reservoir 20.

Similarly, the brake fluid pressure control actuator 50 avoids the pumps 19, 39, the second reservoir 40, and the second wheel pressure sensor 72 being arranged in series by disposing the second wheel pressure sensor 72 on the outer peripheral side of the second reservoir 40, and thus it is possible to reduce the size of the housing 51.

Further, when the first and the second reservoirs 20, 40 are disposed at the positions below the central axes of the pumps 19, 39 and are offset from the center portion in the lateral direction of the housing 51 when viewed from the front surface 511 side, the outer peripheral sides of the first and the second reservoirs 20, 40 usually become dead spaces.

In the present embodiment, since the first and the second wheel pressure sensors 71, 72 are disposed in the dead spaces, the housing can be made smaller than a conventional brake fluid pressure control actuator having a wheel pressure sensor, and can be made to the same size to a housing of a brake fluid pressure control actuator having no wheel pressure sensor.

Further, since the first and the second wheel pressure sensors 71, 72 are positioned within the projecting planes of the first and the second reservoirs 20, 40, respectively, when viewed from the front surface 511 side, it is possible to avoid an increase in dimension of the housing 51 in the lateral and the vertical directions.

### Other Embodiments

In should be noted that the present disclosure is not limited to the above-mentioned embodiment, and can be suitably modified within limits disclosed in the claims.

Further, in the above-mentioned embodiment, elements that constitute the embodiment are not necessarily indispensable except for cases where clearly shown that it is especially indispensable and thought theoretically that it is clearly indispensable etc.

Furthermore, in the above-mentioned embodiment, when numerical values, such as the number of the component, a numerical value, quantity, and a range of the embodiment are mentioned, it is not limited to the specific number except for cases where clearly shown that it is especially indispensable, and it is theoretically limited to a specific number clearly etc.

Moreover, when mentioning shapes or spatial relationship, etc., of elements in the above-mentioned embodiments, it is not in particular limited to the shapes, or spatial relationship, etc. except for cases where clearly shown and when it is theoretically limited to specific shapes, spatial relationship, etc.

What is claimed is:

1. A brake fluid pressure control actuator comprising:
a housing having a front surface, a back surface, and a plurality of side surfaces, and to which piping that connects a master cylinder and wheel cylinders is formed;
a plurality of control valves or controlling a brake fluid pressure applied to the wheel cylinders, the control valves are disposed in the front surface;
a reservoir for temporarily storing a brake fluid discharged from the wheel cylinders, the reservoir being accommodated in a reservoir accommodating hole opened in the first side surface among the plurality of side surfaces;
a pump for sucking the brake fluid from the reservoir and discharging it towards the piping, the pump is accommodated in the housing; and
a wheel pressure sensor for detecting the brake fluid pressure of the wheel cylinders, the wheel pressure sensor being disposed on an outer peripheral side of the reservoir in the housing.

2. The brake fluid pressure control actuator according to claim 1, wherein,
the housing is a rectangular parallelepiped; and
when viewed from the front surface side, the pump is disposed in a position at a center portion in a lateral direction of the housing, and the wheel pressure sensor and the reservoir are disposed in positions below a center axis of the pump and are offset from the center portion in the lateral direction of the housing.

3. The brake fluid pressure control actuator according to claim 1, wherein,
when viewed from the front surface side, the wheel pressure sensor is positioned within a projecting plane of the reservoir.

4. The brake fluid pressure control actuator according to claim 2, wherein,
when viewed from the front surface side, the wheel pressure sensor is positioned within a projecting plane of the reservoir.

5. The brake fluid pressure control actuator according to claim 1, wherein,
the wheel pressure sensor is disposed in the front surface of the housing.

6. The brake fluid pressure control actuator according to claim 2,. wherein, the wheel pressure sensor is disposed in the front surface of the housing.

7. The brake fluid pressure control actuator according to claim 3, wherein, the wheel pressure sensor is disposed in the front surface of the housing.

8. The brake fluid pressure control actuator according to claim 4, wherein,
the wheel pressure sensor is disposed in the front surface of the housing.
